(19) United States
(12) Patent Application Publication
(10) Pub. No.: US 2002/0004711 A1
(43) Pub. Date: Jan. 10, 2002

(54) Control device and control method

(76) Inventors: Makoto Sato, Tokyo (JP); Teruyoshi Komuro, Tokyo (JP)

Correspondence Address: William S. Frommer, Esq., FROMMER LAWRENCE & HAUG LLP, 745 Fifth Avenue, New York, NY, 10151, US

(21) Appl. No.: 09/854,770

(22) Filed: May 14, 2001

(30) Foreign Application Priority Data
May 16, 2000 (JP) 2000-143639

(51) Int. Cl. G06F 11/00; G06F 15/00

(52) U.S. Cl. 702/188

(57) ABSTRACT

A CPU 10 of a receiver 3 that is a control device acquires a DCM contained in a configuration ROM of a digital AV device, and stores such DCM in a RAM 12 when the digital AV device that is a device targeted for control is connected to an IEEE 1394 bus 2. Further, the CPU 10 acquires application software from a digital satellite broadcast or Internet and the like, and stores the software based on identification information (ID) for identifying application software utilizing the DCM and acquisition site information that exist at the DCM or configuration ROM and any other portion. In this way, at the receiver 3, application software is made available automatically. That is, application software utilizing control information (DCM) for controlling a device targeted for control is made available automatically.

### BACKGROUND OF THE INVENTION

1. Field of the Invention

The present invention relates to a control device for controlling a device targeted for control and a control method thereof. More particularly, the present invention relates to a control device or the like for acquiring application software utilizing control information for controlling a device targeted for control from the device targeted for control or another network, thereby making it possible to automatically utilize the application software.

2. Description of Related Art

In recent years, in a home network system, mutual specification called Home Audio Video interoperability (HAVi) is adopted as middleware for integrally managing and controlling a plurality of digital audio/visual (AV) devices connected to an IEEE 1394 bus.

In such home network system, a plurality of digital AV devices connected to the IEEE 1394 bus is divided into controlling digital AV devices (hereinafter, referred to as “control devices”) and controlled digital AV devices (hereinafter, referred to as “devices targeted for control”). The control devices each can hold control information for controlling the device targeted for control in advance or can be acquired from the device targeted for control or another network.

However, even if the control device can acquire control information on each device targeted for control, the control information cannot be utilized in this state, and application software is required for utilizing the control information.

Therefore, in the control device, in order to make this application software available, it is required to store the application software in advance in a secondary storage medium such as memory or hard disk, which has been cumbersome for a user.

### SUMMARY OF THE INVENTION

The present invention has been made in order to solve the foregoing problem. It is an object of the present invention to a control device or the like in which application software is automatically made available in a home network system.

According to one aspect of the present invention, there is provided a control device for controlling a device targeted for control via a communication bus, the control device comprising: first storage means for storing control information for controlling the device targeted for control; first information acquisition means for acquiring application software utilizing control information stored in the first storage means; and second storage means for storing the application software acquired by the first information acquisition means.

According to another aspect of the present invention, there is provided a method for controlling a control device that controls a device targeted for control via a communication bus, the method comprising the steps of: acquiring application software utilizing control information for controlling the device targeted for control stored in first storage means; and storing the acquired application software in second storage means.

In the present invention, control information for controlling a device targeted for control is stored in first storage means. The control information stored in this first storage means is held in advance in the first storage means or is acquired by the device targeted for control or digital satellite broadcast or another network such as Internet. The control information is acquired when the device targeted for control is connected to the communication bus, for example.

In this way, application software utilizing control information stored in the first storage means is acquired by a device targeted for control or digital satellite broadcast or another network such as Internet, for example, and is stored in the second storage means. In this manner application software utilizing control information for controlling each device targeted for control is made available automatically. The application software is acquired when the device targeted for control is connected to the communication bus, for example.

In addition, in the case where control information for controlling a device targeted for control or application software utilizing the control information is acquired by a digital satellite broadcast or another network such as Internet, when the control information or application software is changed, the fact is notified or the control information or application software after changed is acquired, thereby taking immediate action during software updating such as bug modification or addition of new functions.

In addition, when the device targeted for control stored in the second storage means, the device targeted for control corresponding to available application software, is not connected to the communication bus, the fact is notified, thereby making it possible to prompt a user to make connection to the communication bus of the display control device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principle of the present invention.

FIG. 1 is a block diagram depicting an AV system according to one embodiment of the present invention;

FIG. 2 is an illustrative view illustrating an example of a cyclic structure of data transmission via a bus in accordance with an IEEE 1394 system;

FIG. 3 is an illustrative view illustrating an example of a structure of an address space in a CRS architecture;

FIG. 4 is an illustrative view illustrating an example of the position, name, and function of the essential CRS;

FIG. 5 is an illustrative view illustrating an example of a general ROM format;

FIG. 6 is an illustrative view illustrating an example of a bus info block, a root directory, and a unit directory;

FIG. 7 is an illustrative view illustrating an example of PCR configuration;

FIG. 8A to FIG. 8D are illustrative views each illustrating an example of oMPR, oPCR, iMPR, and iPCR configurations;

FIG. 9 is an illustrative view illustrating an example of a relationship among a plug, a plug control register, and a transmission channel;

FIG. 10 is an illustrative view illustrating an exemplary data structure caused by a hierarchical structure of a descriptor;

FIG. 11 is an illustrative view illustrating an example of a data format of a descriptor

FIG. 12 is an illustrative view illustrating an example of a generation ID of FIG. 11;

FIG. 13 is an illustrative view illustrating an example of a list ID of FIG. 11

FIG. 14 is an illustrative view illustrating an example of a stack model of an AV/C command.

FIG. 15 is an illustrative view illustrating a relationship between a command and a response of an FCP;

FIG. 16 is an illustrative view further giving a relationship between a command and a response of FIG. 15 in detail;

FIG. 17 is an illustrative view illustrating a specific example of the AV/C command;

FIG. 18A to FIG. 18C are illustrative views each illustrating a specific example of the AV/C command;

FIG. 19A and FIG. 19B are illustrative views each illustrating a specific example of a command and a response of the AV/C command;

FIG. 20 is an illustrative view illustrating a communication route in a HAVi software architecture;

FIG. 21 is a block diagram depicting a flow of data provided to a media manager;

FIG. 22 is a block diagram depicting a flow of data from a media manager;

FIG. 23 is a block diagram depicting a internal structure of a first receiver that serves as a control device;

FIG. 24 is a flow chart showing acquisition processing of DCM and application software of the control device;

FIG. 25 is a block diagram depicting an internal configuration of a digital VTR that serves as a device targeted for control; and

FIG. 26 is a rough wiring diagram provided for explanation of a HAVi software module.

### DESCRIPTION OF THE PREFERRED EMBODIMENTS

Reference will now be made in detail to the presently preferred embodiments of the invention as illustrated in the accompanying drawings, in which like reference numerals designate line or corresponding parts.

Hereinafter, preferred embodiments of the present invention will be described with reference to the accompanying drawings.

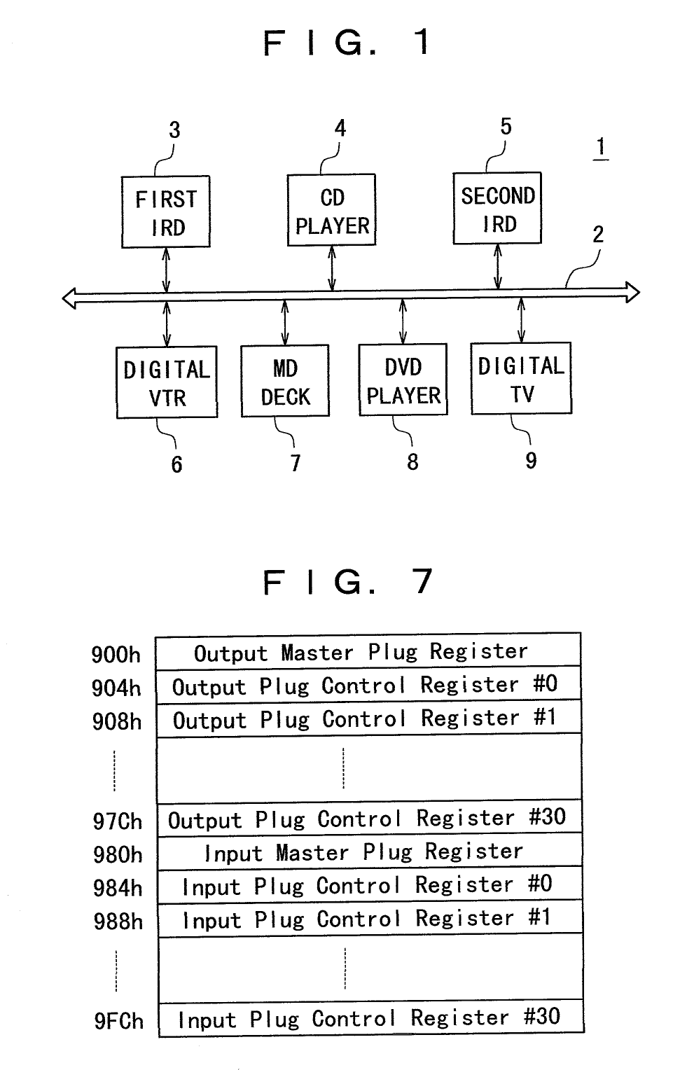

FIG. 1 shows an AV system 1 according to one embodiment of the present invention. This AV system 1 is composed so that a first receiver (Integrated Receiver and Decoder:IRD) 3, a Compact Disc (CD) player 4, a second receiver (IRD) 5, a digital Digital Video Tape Recorder (VTR) 6, an Mini disc (MD) deck 7, a Digital Versatile Disc (DVD) player 8, and a digital Television (digital TV) 9 are connected to each other.

In this AV system 1, for example, a first receiver 3 serving as a control device controls a digital VTR 6, an MD deck 7, and a DVD player 8 respectively as a device targeted for control, and controls a CD player 4 and a digital TV 9 serving as another device targeted for control, as required, by executing HAVi software described later.

In addition, in this AV system 1, for example, a second receiver 5 serving as a control device controls a CD player 4 and a digital TV 9 serving as a device targeted for control, and controls a digital VTR 6, an MD deck 7, and a DVD player, respectively, serving as a device targeted for control, as required, by executing HAVi software described later.

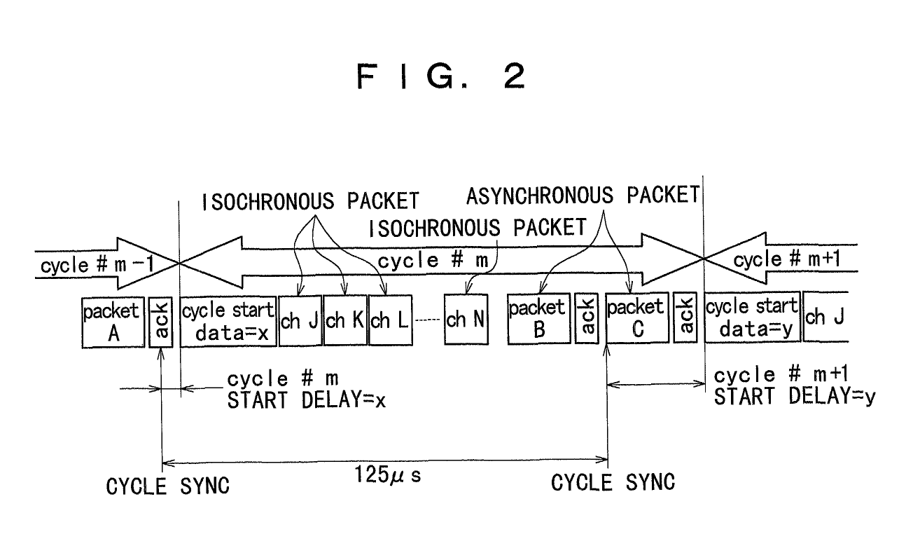

Now, an IEEE 1394 bus will be described here. Communication protocols in which each AV device is connected is the IEEE 1394 bus. FIG. 2 is a view showing a cycle structure of data transmission of the device connected to the IEEE 1394. In the IEEE 1394, data is divided into packets, and is transmitted by time division wen a cycle of 125 μs is defined as a reference.

The cycle described above is created by the cycle start packet supplied from the node having a cycle master function (i.e. any equipment connected to the bus). In the isochronous transmission, the band required for data transmission (although this is a unit of time, it is referred to as a band) is secured from all the foremost end of the cycle. Therefore, in the isochronous transmission, the data transmission is secured for a specified period of time. However, since the isochronous transmission has no arrangement for data protection, the data is lost when transmission error occurs. On the other hand, in the asynchronous transmission, the node which has obtained the right to use the bus as a result of arbitration during the time when the bus is not used for isochronous transmission in each cycle sends the asynchronous packet. The reliable transmission is possible by employment of the acknowledgement and retry; however, the transmission is not executed at a constant timing.

In order to allow a predetermined node to execute isochronous transmission, it is required that the node has the isochronous function. In addition, at least one of nodes having the isochronous function must have also cycle master function. Furthermore, at least one of nodes (AV devices) connected to the IEEE 1394 serial bus must have isochronous resource managing function.

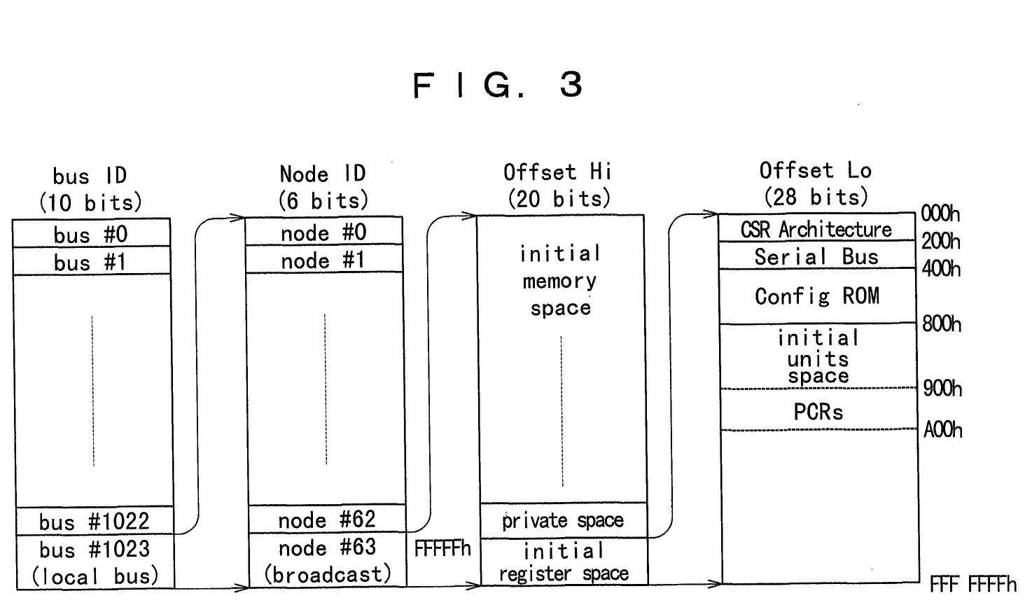

The IEEE 1394 complies with a Control & Status Register (CSR) architecture having a 64-bit address space specified under an ISO/IEC 13213. FIG. 3 is a view illustrating a structure of an address space of the CSR architecture. Upper 16 bits are a node ID indicating a node on each IEEE 1394, and the residual 48 bits are used to specify an address space assigned to each node. The upper 16 bits are further divided into 10 bits of a bus ID and 6 bits of a physical ID (narrow node ID). A value of which all bits are set to 1 is used for a specific purpose, and thus, 1023 buses and 63 nodes can be specified.

Among the address space with 256 terabyte defined by the lower 48 bits, the space defined by the upper 20 bits is divided into an initial register space which is used for the register specific to 2048 byte CSR and the register specific to the IEEE 1394 standard, a private space, and an initial memory space. The space defined by the lower 28 bits is used, when the space defined by the upper 20 bits is an initial register space, as a configuration read only memory (ROM), an initial unit space for use specific to the node, a plug control register (PCRs), or the like.

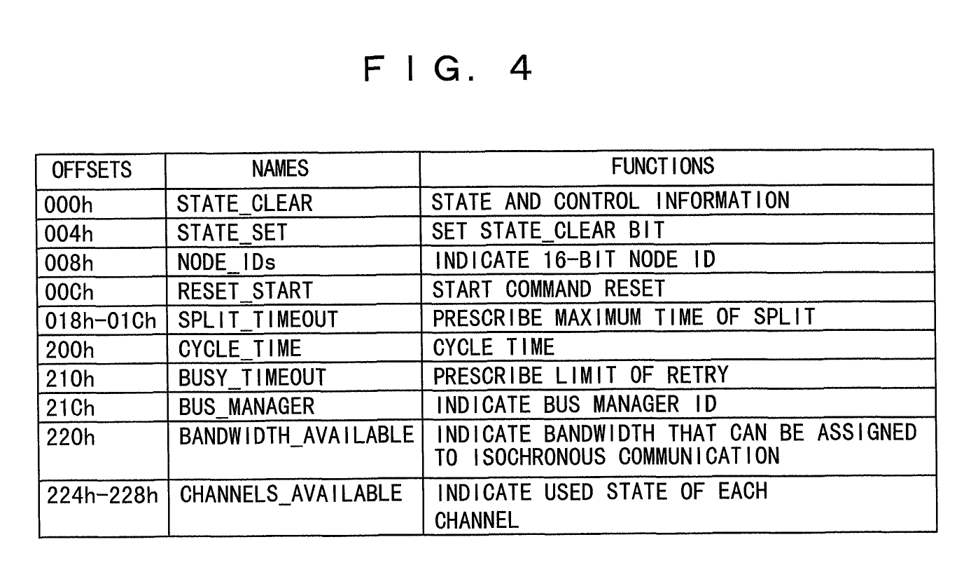

FIG. 4 is a diagram for illustrating an offset address, name, and operation of the main CSR. The term “offset” in FIG. 4 shows the offset address close to the FFFFF0000000h address (the h at the rearmost end indicates that the address is in a hexadecimal notation) from which the initial register space begins. The bandwidth available register having an offset 220h shows a bandwidth which can be allocated to the isochronous transmission, and recognizes only the value of the node activating as an isochronous resource manager to be effective. Specifically, each node has the CSR shown in FIG. 3, whereas only the bandwidth available register of the isochronous resource manager is recognized to be effective. In other words, it is only the isochronous resource manager that actually has the bandwidth available register. In the bandwidth available register, a maximum value is stored when no bandwidth is allocated to the isochronous transmission, and the value thereof is reduced every time when a bandwidth is allocated to the isochronous transmission.

The channels available registers from offset 224h to 228h correspond to the channel numbers with 0 to 63 bits, respectively. In the case where the channel number with 0 bit, it means that the channel has been already allocated to the channels available register. Only the channel available register of the node activating as an isochronous resource manager is effective.

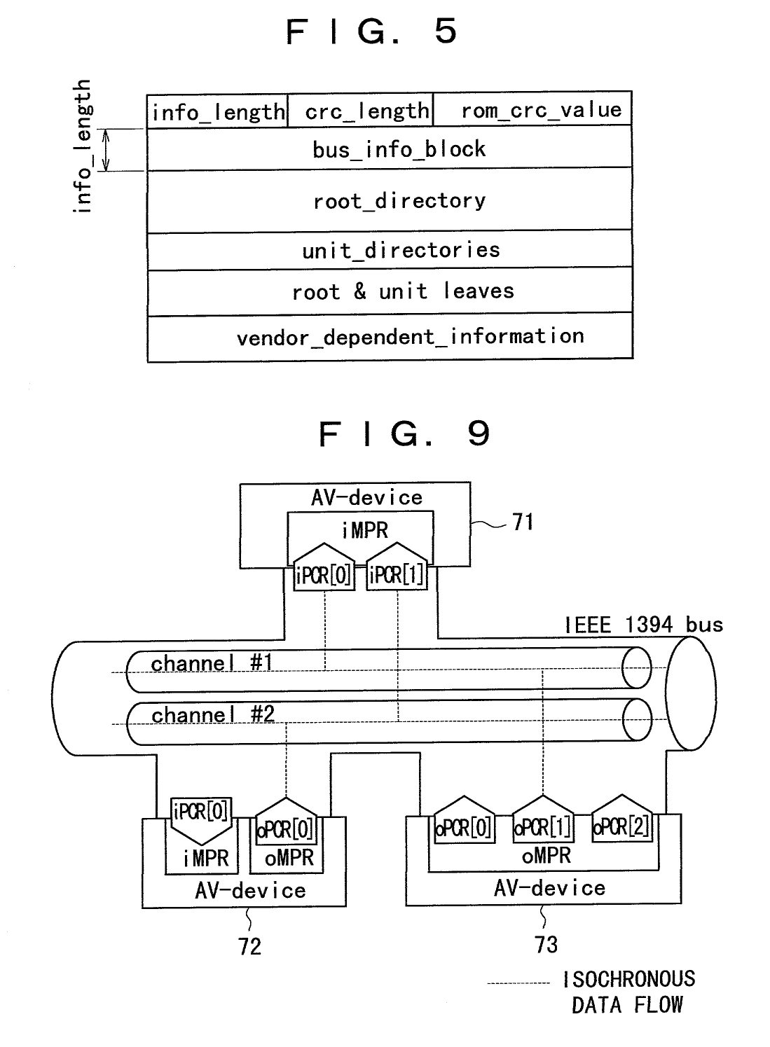

Referring again to FIG. 3, a configuration read only memory (ROM) based on the general read only memory (ROM) format is arranged in the addresses 200h to 400h within the initial register space. FIG. 5 is a diagram for illustrating the general ROM format. The node, which is a unit of access on the IEEE 1394 standard, can hold a plurality of units capable of independently operate while having the common address space in the node. The unit directories can indicate the version and the position of the software for the unit. The bus info block and the root directory are located at fixed positions, and the other blocks are located at positions designated by the offset address.

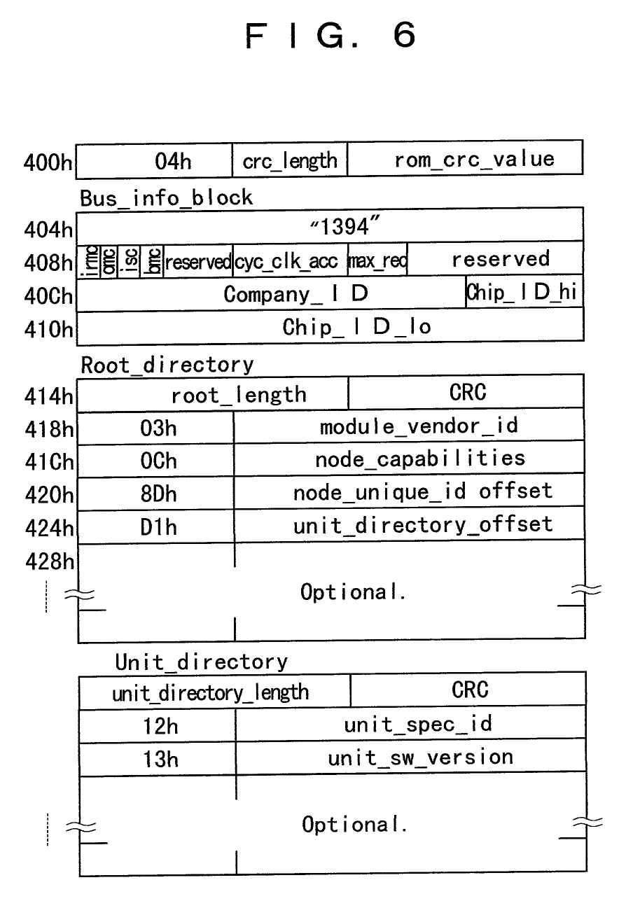

FIG. 6 is a diagram showing bus info block, root directory, and unit directory in detail. An ID number for indicating the manufacturer of the equipment is stored in the company ID in the bus info block. An ID which is specific to the equipment and is the only one ID in the world without overlapping other IDs is stored in the chip ID. 00h is written into the first octet of the unit spec ID of the unit directory of the equipment satisfying the requirements of the IEC 61883 standard, and Aoh is written into the second octet thereof, and 2Dh is written into the third octet thereof, respectively. Furthermore, 01h is written in the first octet of the unit switch version, and 1 is written into the least significant bit (LSB) of the third octet.

The node has a plug control register (PCR) defined by the IEC61883 standard in the addresses 900h to 9FFh within the initial unit space shown in FIG. 3, in order to control an input/output of the equipment via the interface. This design embodies the concept of plug to form a signal path logically similar to an analog interface. FIG. 7 is a diagram for illustrating the structure of PCR. The PCR has an output plug control register (oPCR) indicating an output plug, and an input plug control register (iPCR) indicating an input plug. The PCR also has an output master plug register (OMPR) or an input master plug register (iMPR) for indicating information on the output plug or the input plug specific to each device. Each device does not have a plurality of oMPR nor iMPR, but may have, in accordance with its ability, a plurality of oPCR or iPCR corresponding to each plug thereof. Each of the PCRs shown in FIG. 7 has 31 oPCRs and 31 iPCRs. The isochronous data flow is controlled by manipulating the registers corresponding to these plugs.

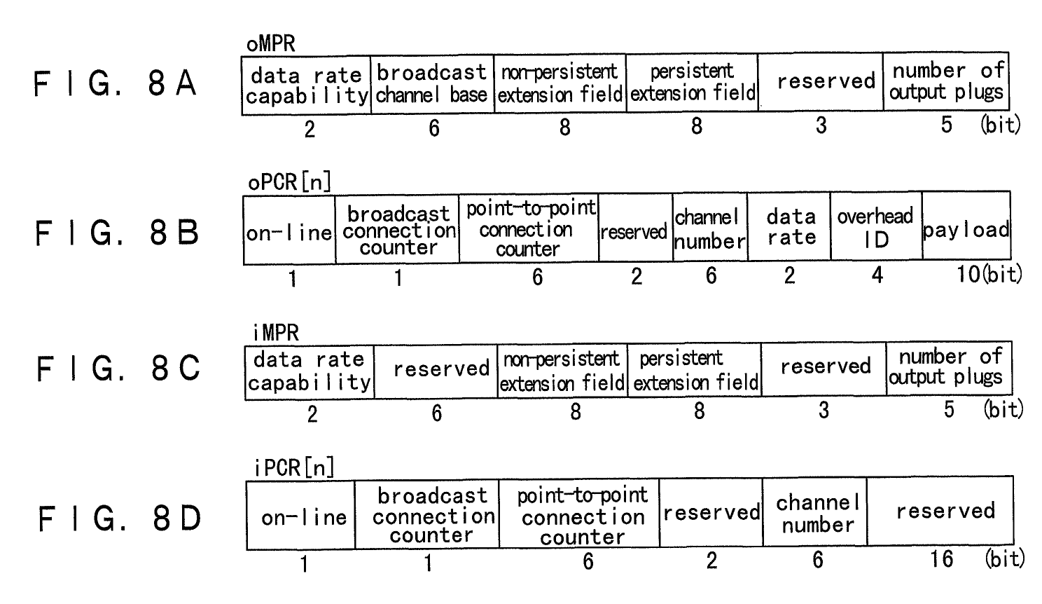

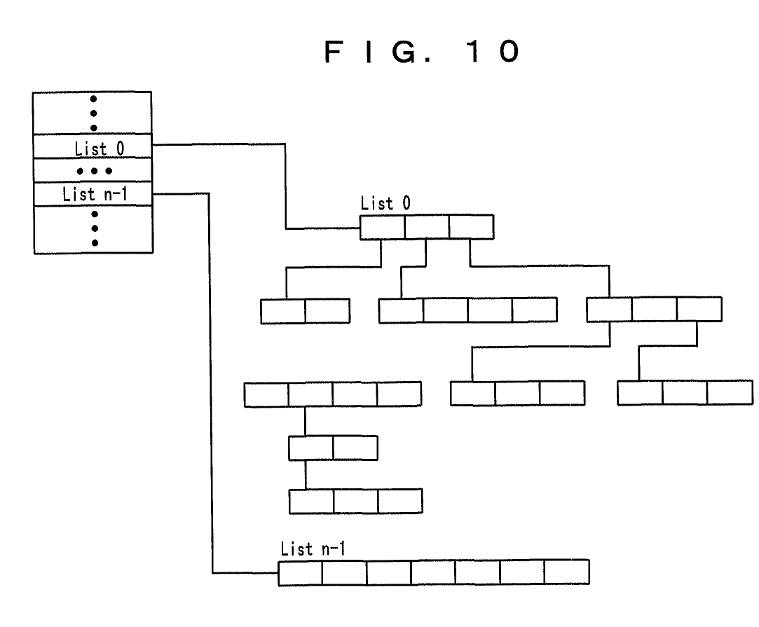

FIGS. 8A to 8D are diagrams showing structures of oMPR, oPCR, iMPR, and iPCR, respectively. FIG. 8A shows the structure of oMPR, FIG. 8B shows the structure of oPCR, FIG. 8C shows the structure of iMPR, and FIG. 8D shows the structure of iPCR, respectively. A code indicating the maximum transmission rate of the isochronous data which the device can send or receive is stored in the data rate capability with 2 bits at the MSB side in each of the oMPR and iMPR. A broadcast channel base in the oMPR defines the channel number to be used for broadcast output.

The number of output plugs that the device has, that is, the value showing the number of oPCRs is stored in the number of output plugs with 5 bits at the LSB side in the oMPR. The number of input plugs that the device has, that is, the value showing the number of iPCR is stored in the number of input plugs with 5 bits at the LSB side in the iMPR. A non-persistent extension field and a persistent extension field are regions prepared for future expansion.

An on-line at the MSB in each of the oPCR and iPCR indicates the use state of the plug. Specifically, the value at 1 on the on-line means that the plug is in an on-line state, and the value at 0 on the on-line means that the plus is in an off-line state. The values on the broadcast connection counter of each of the oPCR and iPCR indicates the presence (the value at 1) or absence (the value at 0) of the broadcast connection. The value on the point-to-point connection counter with 6-bit width in each of the oPCR and iPCR indicates the number of the point-to-point connections that the plug has.

The value on the channel number with 6-bit width in each of the oPCR and iPCR indicates the isochronous channel number to which the plug is to be connected. The value on the data rate with 2-bit width in oPCR indicates an actual transmission rate of the packet of the isochronous data to be output from the plug. The code stored in the overhead ID with 4-bit width in the oPCR shows the bandwidth over the isochronous communication. The value on the payload with 10-bit width in the oPCR indicates the maximum value of the data involved in the isochronous packet that can be handled by the plug.

FIG. 9 is a diagram showing the relationship between the plug, the plug control register, and the isochronous channel. AV-devices 71 to 73 are connected with each other by IEEE 1394 serial bus. The oMPR in the AV device 73 defines the number and the transmission rate of the oPCR[0] to oPCR[2]. The isochronous data for which the channel is designated by the oPCR [1] among the oPCR [0] to oPCR[2] is sent to the channel #1 in the IEEE 1394 serial bus. The iMPR in the AV device 71 defines the number and transmission rate of iPCR[0] and iPCR[1]. The AV device 71 read the isochronous data which has been sent to the channel #1 in the IEEE 1394 serial bus which is designated by the iPCR[0] between the iPCR[0] and iPCR[1]. Similarly, the AV device 72 sends the isochronous data to the channel #2 designated by the oPCR[0]. The AV device 71 reads the isochronous data from the channel #2 designated by the iPCR[1].

In the aforementioned manner, data transmission is executed between the devices connected to each other by the IEEE 1394 serial bus. In this structure, each device can be controlled and the state thereof can be acknowledged by use of an AV/C command set defined as a command for controlling the devices connected to each other by the IEEE 1394 serial bus. Hereinafter, the AV/C command set will be described.

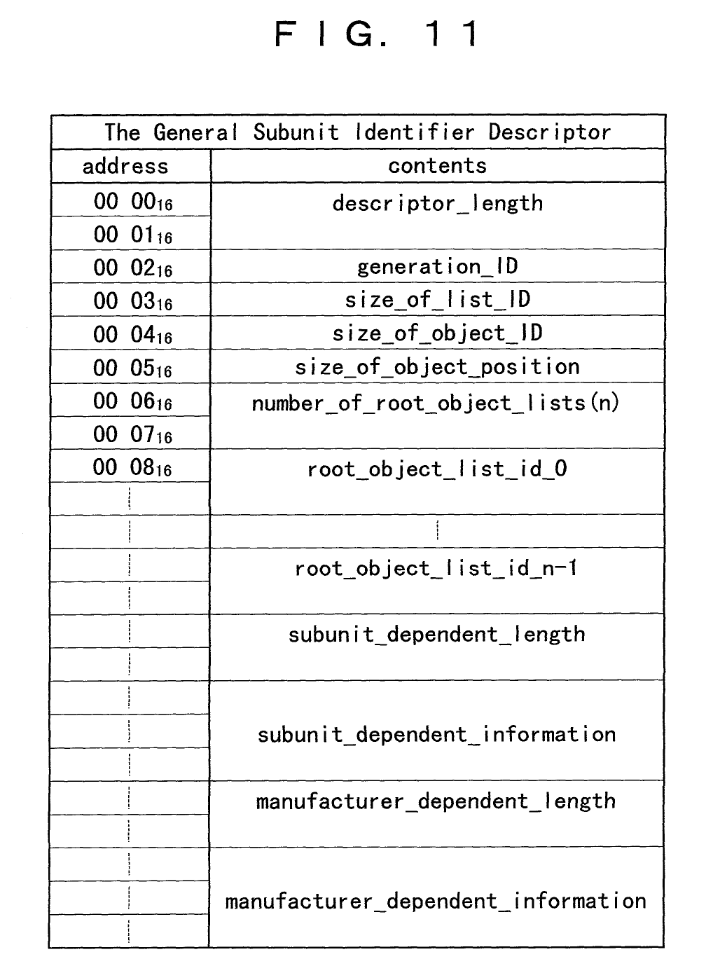

First, description will be made on a data structure of the subunit identifier descriptor in the AV/C command set, referring to FIGS. 10 to 13. FIG. 10 is a diagram showing a data structure of the subunit identifier descriptor. As seen in FIG. 10, the data structure of the subunit identifier descriptor is constituted by hierarchical lists. The term “list” means, in the case of a tuner for example, a channel through which data can be received, and means, in the case of a disc for example, a music recorded therein. The uppermost list in the hierarchy is referred to as a root list, and a list 0 is a root for the lists at lower positions for example. Similarly, the lists 2 to (n−1) are also root lists. The root lists exist in the same numbers as of the objects. The term “object” means, in the case where the AV device is a tuner, each channel in a digital broadcasting. All the lists in one hierarchy share the same information.

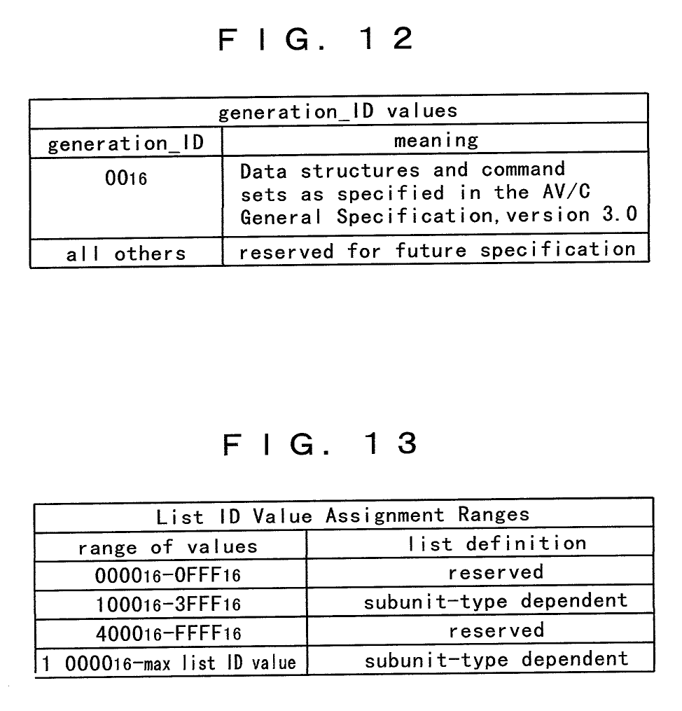

FIG. 11 is a diagram showing a format of the general subunit identifier descriptor. The subunit identifier descriptor 41 has contents including attribute information as to the functions. No value of the descriptor length field itself is involved in the contents. The generation ID indicates the AV/C command set version, and its value is at “00h” (the h designates that this value is in hexadecimal notation) at present as shown in FIG. 12. The value at “00h” means that the data structure and the command are of AV/C general specification, version 3.0. In addition, as shown in FIG. 12, all the values except for “00h” are stored in reserved states for future specification.

The size of list ID shows the number of bytes of the list ID. The size of object ID shows the number of bytes of the object ID. The size of object position shows the position (i.e. the number of bytes) in the lists to be referred in a control operation. The number of root object lists show the number of root object lists. The root object list ID shows an ID for identifying the uppermost root object list in the independent layers in the hierarchy.

The subunit dependent length means the number of bytes of the subsequent subunit dependent information field. The subunit dependent information is a field showing information specific to the functions. The manufacturer dependent length shows the number of bytes of the subsequent manufacturer dependent information field. The manufacturer dependent information is a field showing information about the specification determined by the vender (i.e. manufacturer). When the descriptor has no manufacturer dependent information, the manufacturer dependent information field does not exist.

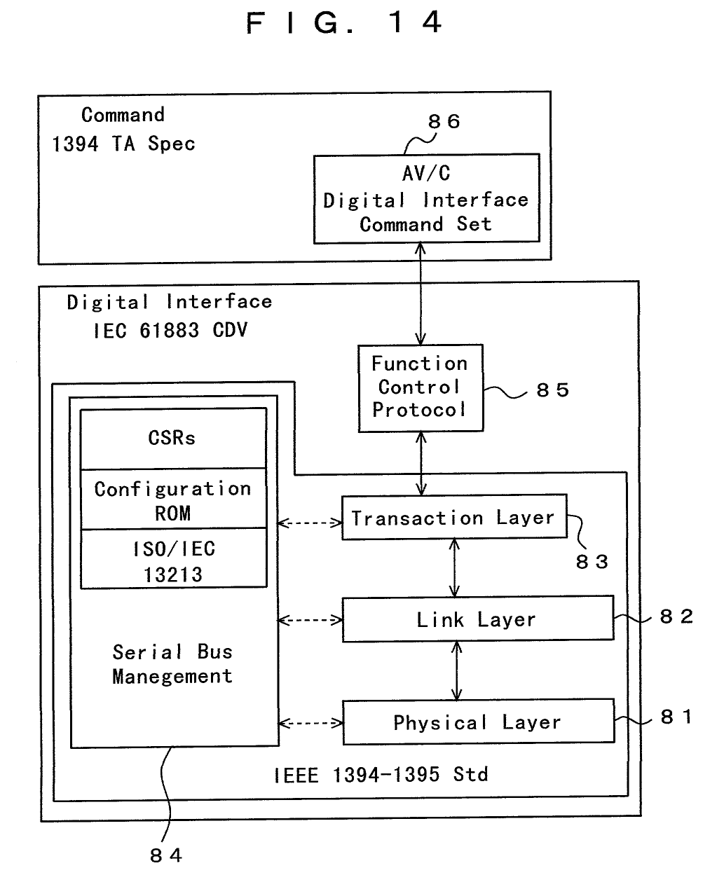

FIG. 13 is a diagram showing the list ID assignment ranges shown in FIG. 11. As shown in FIG. 13, the values at “0000h to 0FFFh” and “4000n to FFFFh” are stored in reserved states for future specification. The values at “1000h to 3FFFh“”and “10000h to max list ID value” are prepared for identifying dependent information about function type.

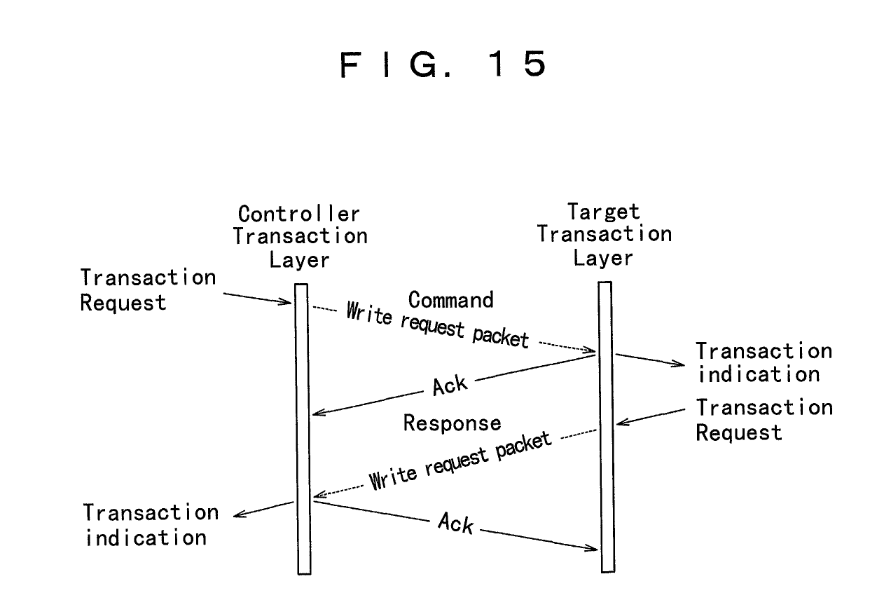

Now, an AV/C command set used in a system of the present embodiment will be described with reference to FIG. 14 to FIG. 19. FIG. 14 shows a stack model of the AV/C command set. As shown in FIG. 14, a physical layer 81, a link layer 82, a transaction layer 83, and a serial bus management 84 conform with the IEEE 1394. A Function Control Protocol (FCP) 85 conforms with an IEC 61883. An AV/C command set 86 conforms to a 1394 TA specification.

FIG. 15 is a diagram for illustrating the command and the response of an FCP 85 of FIG. 14. The FCP is a protocol for controlling the AV device in conformity to the IEEE 1394 standard. As shown in FIG. 15, a controller is a control side, and a target is a side to be controlled. In the FCP, the command is transmitted and received between nodes by use of the write transaction in the IEEE 1394 asynchronous transmission. Upon receiving data from the controller, the target returns an acknowledgement to the controller for notifying that it has received the data.

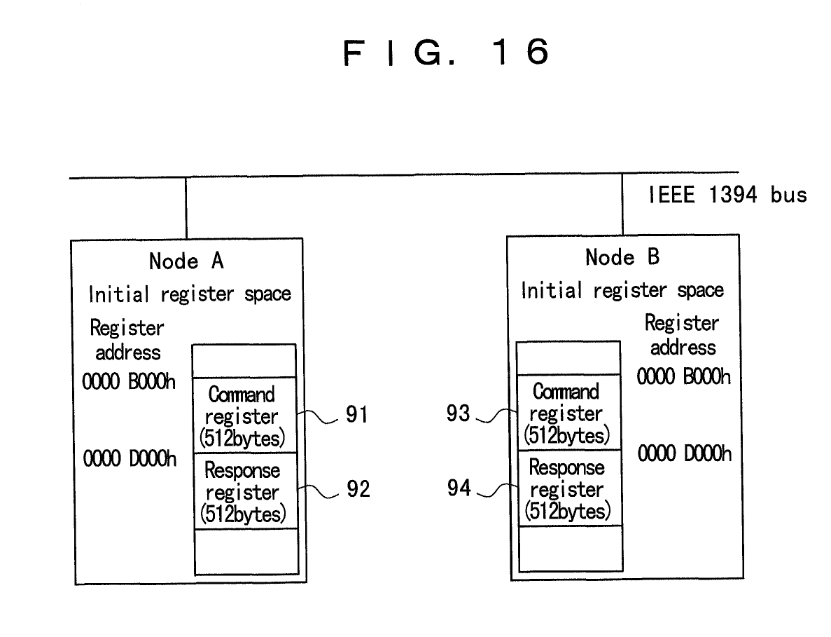

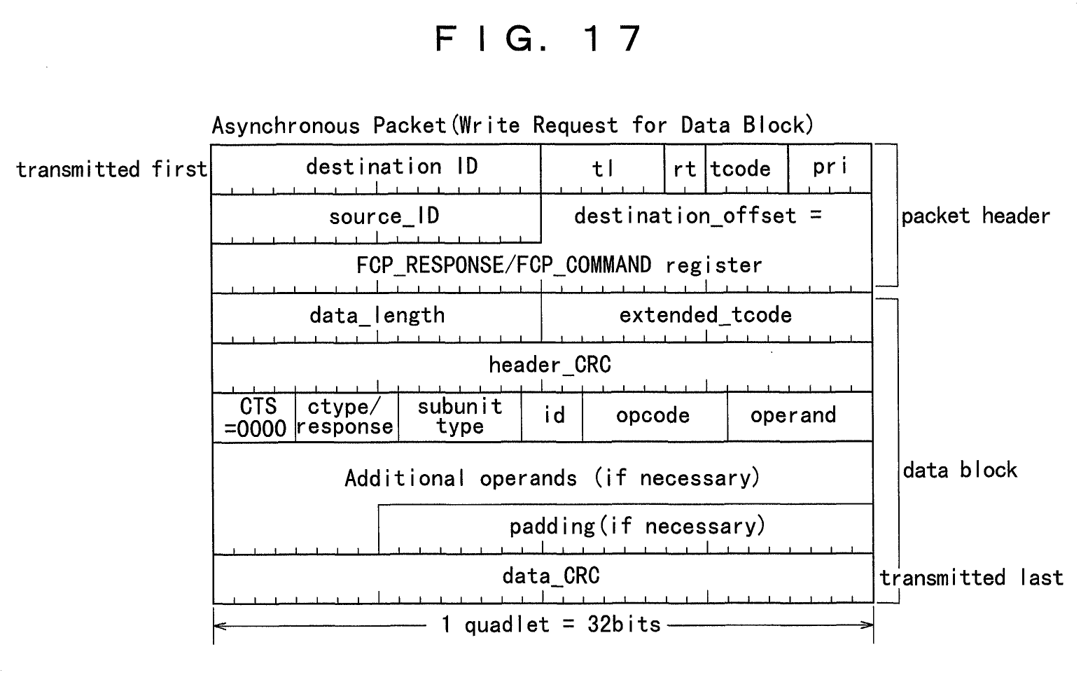

FIG. 16 is a diagram for further illustrating the relationship between the command and the response of FCP shown in FIG. 15. A node A is connected with a node B via an IEEE 1394 bus. The node A is a controller, and the node B is a target. Each of the nodes A and B is provided with a command register and a response register each with 512 bytes. As shown in FIG. 16, the controller writes a command massage into a command register 93 in the target to give command thereto. Contrarily, the target writes a response message into a response register 92 in the controller to give response thereto. Between these two messages, control information is exchanged. The kind of the command set sent in the FCP is written in the CTS in the data field shown in FIG. 17 which will be described later.

FIG. 17 is a diagram showing a data structure of a packet of the AV/C command to be transmitted in the asynchronous transmission. The AV/C command set is a command set for controlling the AV device where CTS (i.e. a command set ID)=“0000”. The AV/C command frame and the response frame are exchanged between nodes by use of the FCP described above. In order to prevent burdening the bus and the AV device, the time for the response to the command is limited within 100 ms. As shown in FIG. 17, the asynchronous packet data is constituted by 32 bits in a horizontal direction (i.e. quadlet). A header of the packet is shown in the upper half portion of FIG. 17, and a data block is shown in the lower half portion of FIG. 17. The destination_ID shows an address.

The CTS shows the command set ID, wherein CTS=“0000” in the AV/C command set. The ctype/response field shows the function sort of the command when the packet is a command, while shows the result of command processing when the packet is a response. The command is roughly classified into four categories as follows: (1) a command for controlling the function from the outside (CONTROL); (2) a command for inquiring the state from the outside (STATUS); (3) a command for inquiring whether or not there is a support for control command from the outside (GENERAL INQUIRY for inquiring whether or not there is a support for opcode, and SPECIFIC INQUIRY for inquiring whether or not there is a support for opcode and operands); and (4) a command for requesting to notify the change in the state to the outside (NOTIFY).

What response is returned depends on the kind of the command. The response to the control command is categorized into NOT IMPLEMENTED, ACCEPTED, REJECTED, and INTERIM. The response to the status command is categorized into NOT IMPLEMENTED, REJECTED, IN TRANSITION, and STABLE. The response to the general inquiry command and the specific inquiry command is categorized into IMPLEMENTED and NOT IMPLEMENTED. The response to the notify command is categorized into NOT IMPLEMENTED, REJECTED, INTERIM, and CHANGED.

The subunit type is provided to specify the function in the device, and is assigned with a tape recorder/player, tuner, and the like. In order to identify each subunit from the others in the case where a plurality of subunits of the same kind other exist, the subunit type executes addressing by use of a subunit ID as an identification number. The opcode shows a command, and the operand shows a parameter of the command. The additional operands are fields added if necessary. The padding is a field also added if necessary. The data cyclic redundancy check (CRC) is used for error check in data transmission.

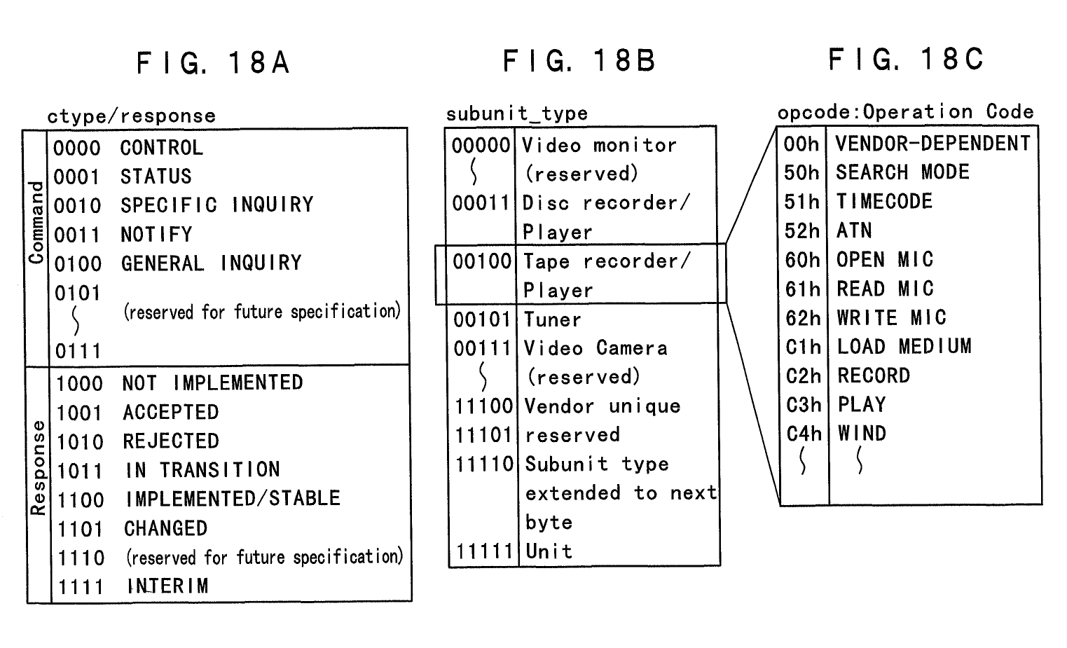

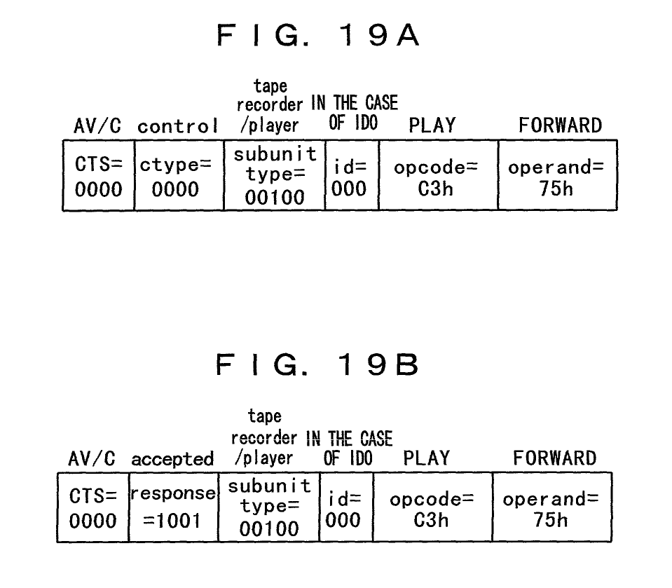

FIGS. 18A to 18C are diagrams showing specific examples of the AV/C command. FIG. 18A shows a specific example of the ctype/response. The upper half portion of FIG. 18A shows command, while the lower half portion of FIG. 18A shows responses. The value at “0000” is assigned with CONTROL, the value at “0001” is assigned with STATUS, the value at “0010” is assigned with SPECIFIC INQUIRY, the value at “0011” is assigned with NOTIFY, and the value at “0100” is assigned with GENERAL INQUIRY. The values at “0101” to “0111” are stored in a reserved state for future specification. In addition, the value at “1000” is assigned with NOT INPLEMENTED, the value at “1001” is assigned with ACCEPTED, the value at “1010” is assigned with REJECTED, the value at “1011” is assigned with IN TRANSITION, the value at “1100” is assigned with IMPLEMENTED/STABLE, the value at “1101” is assigned with CHANGED, and the value at “1111” is assigned with INTERIM. The value at “1110” is stored in a reserved state for future specification.

FIG. 18B shows a specific example of the subunit type. The value at “00000” is assigned with a video monitor, the value at “00011” is assigned with a disk recorder/player, the value at “00100” is assigned with a tape recorder/player, the value at “00101” is assigned with a tuner, the value at “00111” is assigned with a video camera, the value at “11100” is assigned with a vendor unique, the value at “11110” is assigned with a subunit type extended to next byte. The value at “11111” is assigned with a unit, and is used for transmitting data to the device itself, for example, for turning on and off the electric power source.

FIG. 18C shows a specific example of the opcode. Each subunit type has its own opcode table, and FIG. 18C shows the opcode in the case where the subunit type is a tape recorder/player. In addition, operand is defined for each opcode. In the example of FIG. 26C, the value at “00h” is assigned with VENDOR-DEPENDENT, the value at “50h” is assigned with SEARCH MODE, the value at “51h” is assigned with TIMECODE, the value at “52h” is assigned with ATN, the value at “60h” is assigned with OPEN MIC, the value at “61h” is assigned with READ MIC, the value at “62h” is assigned with WRITE MIC, the value at “C1h” is assigned with LOAD MEDIUM, the value at “C2h” is assigned with RECORD, the value at “C3h” is assigned with PLAY, and the value at “C4h” is assigned with WIND.

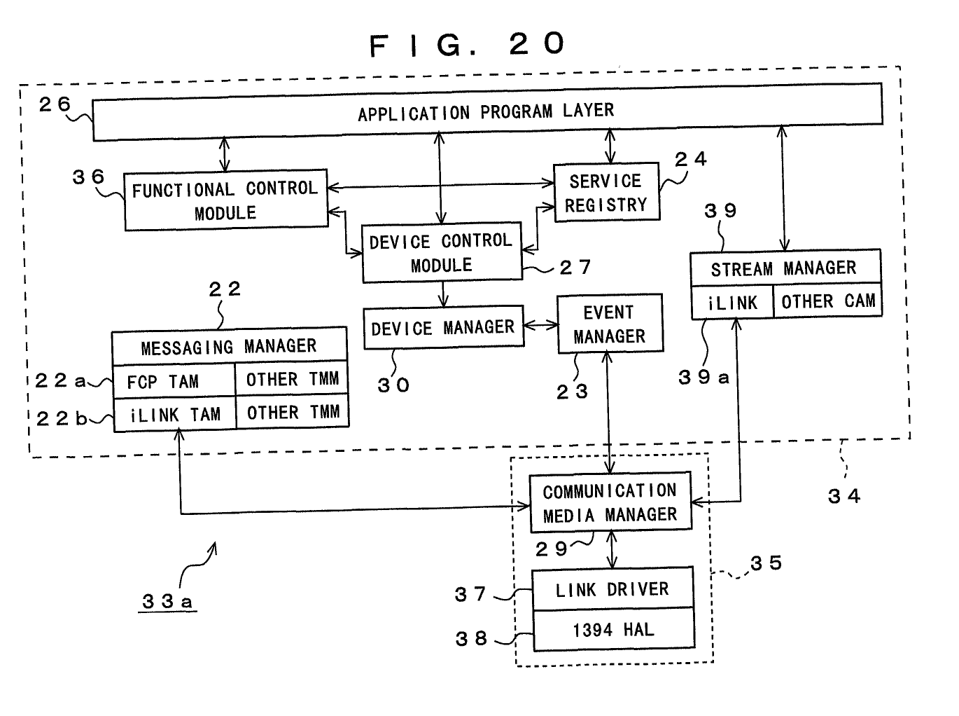

FIGS. 19A and 19B show specific examples of the AV/C command and response. For example, when instruction for executing reproduction is provided to the reproducing device as a target (consumer), the controller sends a command such as shown in FIG. 19A to the target. Since this command uses AV/C command set, the CTS is at the value at “0000”. Since the command for controlling the device from the outside (CONTROL) is used for the ctype, the ctype is at the value at “0000” (see FIG. 18A). Since the subunit type is a tape recorder/player, the subunit type is at the value at “00100” (see FIG. 18B). The id shows the case of 1D0, wherein the id is at the value of 000. The opcode is at the value of C3h which means reproduction (see FIG. 18C). The operand is at the value of 75h which means FORWARD. When reproduced, the target returns the response such as shown in FIG. 19B to the controller. In the example shown in FIG. 19B, “accepted”, meaning that the data has been received enters the response, and therefore, the response is at the value of “1001” (see FIG. 18A). Except for the response, the other configurations of FIG. 19B is basically the same as of FIG. 19A, and therefore, their descriptions will be omitted.

Now, HAVi architecture software that is middleware provided between the above described IEEE 1394 bus and an application will be described here. The HAVi architecture software can be considered to be composed of three application program interfaces (hereinafter, referred to as an API), i.e., AVOS/API, mutual control API, and application API. The AVOS/API is a lower API that governs common operation system functions such as thread communication or storage. The mutual control API is a common device control model that has a function for providing a basic representation model, and further, extending its control model by a command specific to each manufacturer. The application API is the above API that contains an interactive television application or the like, for example.

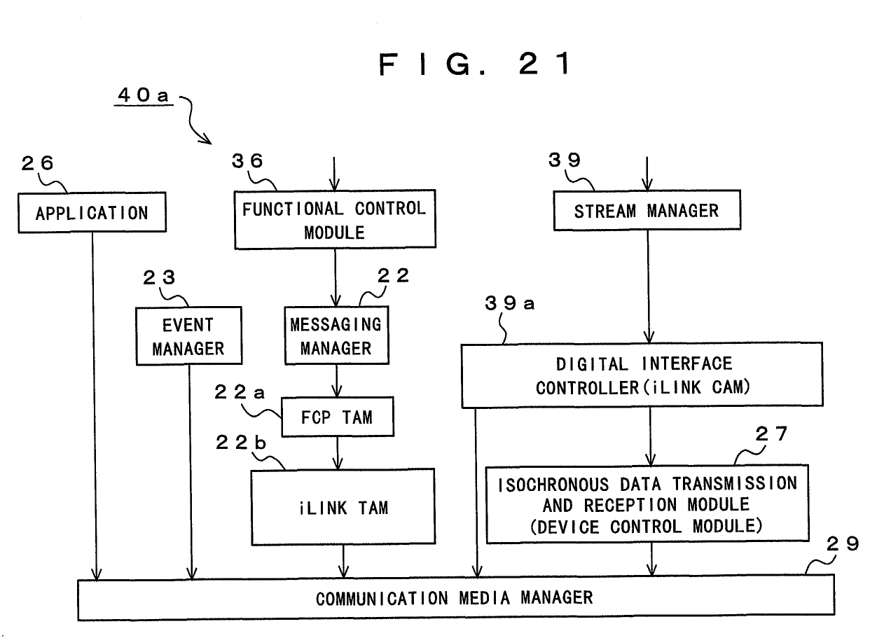

A diaphragm 33a shown in FIG. 20 is a data flow diaphragm of a HAVi software architecture 20 that contains a local bus HAL layer of a local bus 2. In this diaphragm 33a, the top layer is an application program layer 26. The application program layer 26 is connected to a functional control module layer 36 that has the above described AV/C command. In addition, the application program layer 26 is provided inside of a predetermined device, and is connected to a device control model 27, a service registry 24 and a stream manager 39.

The device control module 27 is controlled by means of a device manager 30 connected to an event manager 23. The event manager 23 is connected to a communication media manager 29. The stream manager 39 is inserted between the communication media manager 29 and the application program layer 26, and the application program layer 26 and the communication media manager 29 can transmit and receive data each other by means of this stream manager 39. The communication media manager 29 is connected to a message manager 22 as well.

The communication media manager 29 provides an interface to an IEEE 1394 interface 38 that is a local interface via a link driver unit 35. The link driver unit 35 governs a function for updating a GUID list when a local bus reset occurs.

An IEEE 1394 HAL interface 38 makes communication with a serial bus management 84 shown in FIG. 14. The transaction layer 83 executes a readout transaction, a write transaction, a lock transaction, and a track pending transaction. In addition, in the case where communication has completed due to congestion of communication lines or time-out of a communication time, communication is re-executed by a re-execution protocol (retry protocol). Data is transmitted by means of a link layer 82 and a physical layer 81.

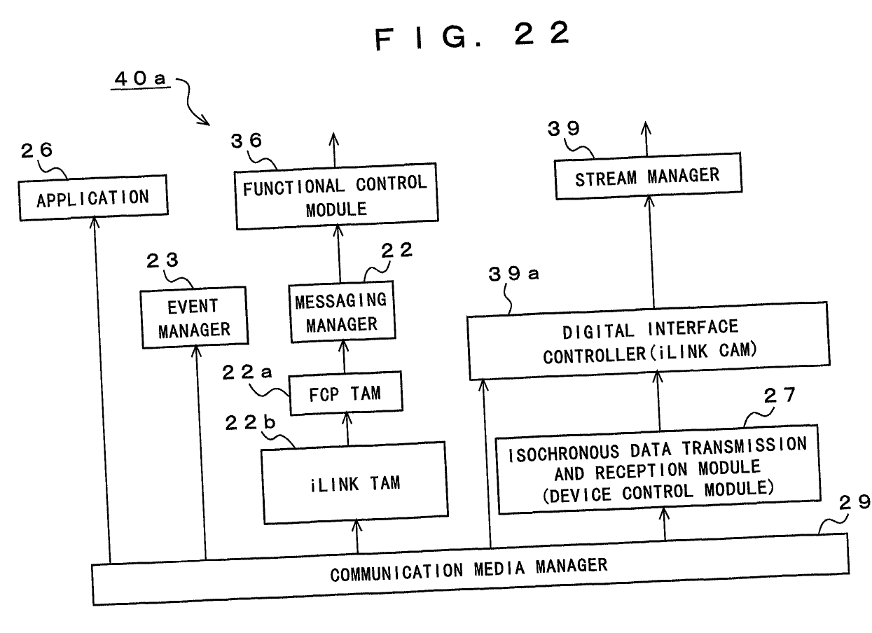

As described above, a local bus HAL layer 34 indicates an upper application, and a link driver unit 35 indicates a lower application. This diaphragm 33a will be described later in more detail by referring to FIG. 22.

A diaphragm 40a shown in FIG. 21 indicates a communication channel that can be used for communication with the communication media manager 29. An application program layer 26 accesses the communication media manager 29, and receives bus generation information, a GUID list a speed map, a topology map or the like.

An iLink transportation adaptation module (iLinkTAM) 22b makes connection to the communication media manager 29, and makes an asynchronous request and an asynchronous response. A digital interface control 39a (iLink connection adaptation module; iLink CAM) makes connection to the communication media manager 29, and makes an asynchronous request, an asynchronous response, channel allocation, channel release, bandwidth allocation, and bandwidth release or the like. The stream manager 39 establishes point to point communication (PtoP) via a digital interface controller 39a by utilizing GUID information. The device control module 27 makes communication with the communication media manager 29 by employing isochronous data.

A diaphragm 40b shown in FIG. 22 illustrates a communication channel for communication in which the communication media manager 29 makes relevant to another object. The communication media manager 29 supplies an instruction to an event manager 23 to reset a bus. The communication media manager 29 manages status information concerning a device currently connected to a local bus 2. That is, the manager manages information on addition and removal of devices after the GUID list has been prepared. The communication media manager 29 transmits GUID information or bus reset information to an iLinkTAM 22b, and performs asynchronous reception or isochronous reception. The communication media manager 29 supplies similar information to a device control module 27 that functions as an isochronous data transmission and reception module as well. Information concerning devices currently connected to the local bus 9 is supplied to a digital interface controller 39a as well.

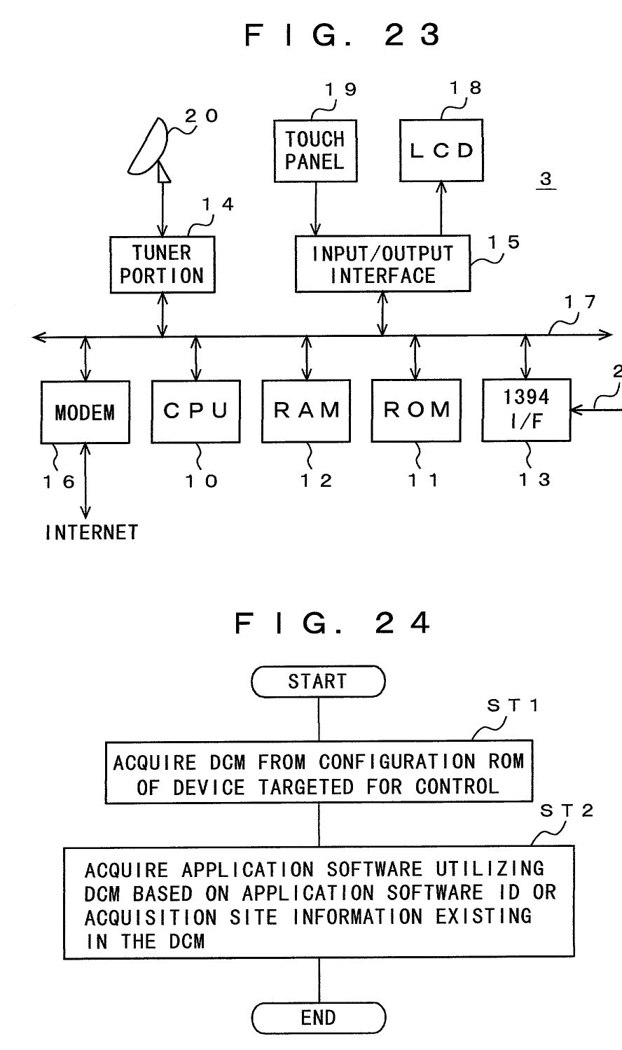

Now, a description will be given with respect to a control device connected by a bus in accordance with the IEEE 1394 system to which the above described HAVi architecture is applied. FIG. 23 shows an internal configuration of hardware of a first receiver 3. In this first receiver 3, there are interconnected a Central Processing Unit (CPU) 10; a read only memory (ROM) 111 in which a variety of programs or a variety of information containing HAVi are stored; a random access memory (RAM) 12 that is a work memory of CPU 10; an interface circuit 13; a tuner portion 14; a modem 16 to be connected to an input/output interface circuit 15 and Internet, respectively, via an internal bus 17.

A Liquid Crystal Display (LCD) 18 and a touch panel 19 are connected to an input/output interface circuit 15, and a digital satellite broadcast reception antenna 20 is connected to a tuner portion 14. A ROM 11 contains a configuration ROM, and this configuration ROM stores text data indicating device name; and HAVi information containing a device control module (DCM) serving as control information or the like. The control device acquires a DCM from a device targeted for control, and controls a device targeted for control based on this DCM. In addition, HAVi information or the like is stored at a site suitable to configuration ROM.

Here, CPU 10 transmits display data based on a program stored in ROM 11 to LCD 18 sequentially via an interface bus 17 and an input/output interface circuit 15, thereby displaying information required for the LCD 18.

In addition, the CPU 10 controls a variety of commands input via a touch panel 19 and a tuner portion 14 and an IEEE 1394 interface circuit 13 as required based on a command supplied from digital AV devices 4 to 9 (refer to FIG. 1).

In addition, the CPU 10 acquires a DCM contained in a configuration ROM of the digital AV device, and stores the DCM when digital AV devices 4 to 8 that are devices targeted for control are connected to the IEEE 1394 bus 2. Similarly, the application software is acquired to be stored in RAM 12 based on identification information (ID) for identifying application software utilizing the DCM that exists at the DCM, configuration ROM or any other portion; and acquisition site information. Here, the application software utilizes a plurality of DCMs for controlling a plurality of digital AV devices without being limited to utilization of one DCM for controlling one digital A device.

Acquisition of DCM or the like from the configuration ROM of a digital AV device that is a device targeted for control is performed by utilizing an IEEE 1394 read transaction. In addition, the application software acquisition site information may contain, for example, an address of a memory in a digital AV device that is the device targeted for control and Universal Resource Locator (URL) of digital satellite broadcast channel or Internet.

When the acquisition site information is a digital satellite broadcast channel, the tuner portion 14 controls selection of the channel, and acquires application software from a digital broadcast signal of that channel. In addition, when the acquisition site information is an Internet URL, the modem 16 access a home page of the URL, and downloads application software from that home page.

A flow chart shown in FIG. 24 indicates acquisition processing of the above described DCM and application software. This acquisition processing is executed when the device targeted for control is connected to the IEEE 1394 bus 2, as described above.

First, at the step ST1, a DCM is acquired from the configuration ROM of a device targeted for control. Next, at the step ST2, application software using the DCM is acquired based on identification information (ID) for identifying application software that exists in the DCM or the like and acquisition site information.

This first receiver 3 select a predetermine channel when a reception command of the predetermined channel for a digital satellite broadcast is supplied from a touch panel 19. This first receiver 3 transmits the obtained video signal or audio signal to the corresponding digital AV device sequentially via the internal bus 17, IEEE 1394 interface circuit 13, and IEEE 1394 bus 2.

As described above, CPU 10 of the first receiver 3 that is a control device indicates a DCM for controlling a digital AV device that is a device targeted for control is acquired from the configuration ROM of the digital AV device. However, the first receiver 3 may store in ROM 11 in advance the DCM for controlling a digital AV device that is a device targeted for control. Alternatively, only DCM acquisition site information is stored in the configuration ROM of the digital AV device that is a device targeted for control. The CPU 10 of the first receiver 3 may acquire the DCM via a digital satellite broadcast or Internet, for example, based on the DCM acquisition site information.

An internal configuration of the second receiver 5 is similar to that of the above described first receiver 3, although a detailed description is omitted.

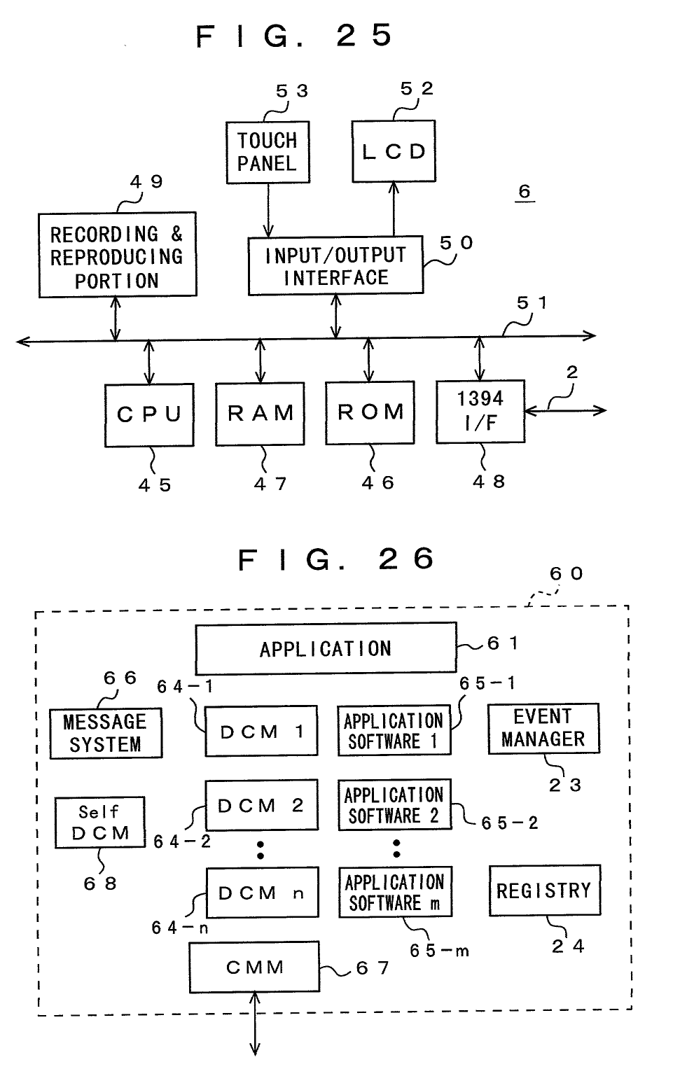

Now, a device targeted for control will be described here. Here, a digital VTR6 will be described. FIG. 25 shows an internal configuration of the digital VTR6. This digital VTR6 mutually connects a CPU 45, a ROM 46 having a variety of programs and a variety of information stored therein; a RAM 47 serving as a work memory of CPU 45; an IEEE 1394 interface circuit 48; a recording & reproducing portion 49, and an input/output interface circuit 50, respectively via an internal bus 51.

A Liquid Crystal Display (LCD) 52 and a touch pane 53 are connected to an input/output interface 50. A ROM 46 contains a configuration ROM; and HAVi information containing text data indicating device name; device control module (DCM) that is control information or the like are stored in this configuration ROM. In addition, at this DCM, configuration ROM, or any other portion, there exists identification information (ID) for identifying application software utilizing the DCM; and acquisition site information. This acquisition site information contains an address of a memory in the digital AV device that is the device targeted for control and URL or the like for digital satellite broadcast channel or Internet, for example.

Here, the CPU 45 transmits display data based on a program stored in the ROM 46 to an LCD 52 sequentially via an internal bus 51 and an input/output interface circuit 50, thereby displaying information required for the LCD 52. In addition, the CPU 45 controls a recording & reproducing portion 49 as required, based on a variety of instructions inputted via the touch panel 53 or a command supplied from the first and second receivers 3 and 5 (refer to FIG. 1) via the IEEE 1394 bus 2.

In this digital VTR 6, when a video signal or audio signal recording instruction is supplied from a predetermined digital AV device, for example, the video signal or audio signal supplied from the digital AV device via the IEEE 1394 bus 2 is acquired at the recording & reproducing portion 49 sequentially via the IEEE 1394 interface circuit 48 and internal bus 51, and is recorded in a magnetic tape.

In addition, in this digital VTR 6, when a reproducing instruction is supplied, for example, a video signal or an audio signal is reproduced from the magnetic tape at the recording & recording portion 49. This signal is transmitted to the corresponding digital AV device sequentially via the internal bus 51, IEEE 1934 interface circuit 48, and IEEE 1394 bus 2.

Now, a software configuration in the first receivers 3 and 5 will be further described in detail. The software in the receivers 3 and 5 is composed of a HAVi software module 60 as shown in FIG. 26. This module 60 consists of elements such as application 61; event manager 23; registry 24, a plurality of DCMs 64-1 to 64-n for controlling devices targeted for control; a plurality of application software components 65-1 to 65-m utilizing these plurality of DCM 64-1 to 64-n; a message system 66; communication media manager (CMM) 67; and self device control module (self DCM) 68.

A variety of graphical user interfaces (GUI) is provided to an application 61, and an application program for executing a variety of events is stored. This application 61 acquires a DCM for controlling each of a plurality of devices targeted for control in a module 60 via an IEEE 1394 bus 2, and reads attribute information on a device targeted for control according to the DCM by inquiring the registry 24. In addition, the application 41 transmits a variety of instructions to each of the above described software element of the event manager 23, and receives the result as a return value obtained when processing contents according to the instruction is executed to a DCM targeted for control by each of these software elements.

A registry 24 is HAVi software directory service, and all software elements on a home network can be recognized. This registry 24 stores in a list form the attribute information that corresponds to all the digital AV devices 3 to 9 on the home network.

An event manager 23 is a software element that manages an event that takes place in the home network (a new device is connected in a network or one device is disconnected by the network, whereby a network state is changed). This event manager 23 notifies a specific event to the software element registered in advance in that event, if such a specific event occurs.

A CMM 67 acts as an interface between an IEEE 1394 bus 2 and an interface between each software module and an application in the HAVi software module 60. This CMM 67 provides a communication mechanism for transmitting and receiving a signal between devices connected to the IEEE 1394 bus 2

A message system 66 acts as an application program interface (API) for making communication between software modules of each device over a network, and serves to transmit a message between the software modules. Thus in a network using the HAVi software, message transmitting and receiving parties can transmit a message without knowing a mutual network site.

As has been described above, in the present embodiment, the first and second receivers 3 and 5 that are control devices acquires a DCM from a respective one of the configuration ROMs of digital AV devices 4 and 6 to 9 that are devices targeted for control, when the digital AV devices are connected to the IEEE 1394 bus 2. In addition, these receivers acquire application software using such DCM from the digital AV device, digital satellite broadcast or another network such as Internet. Therefore, in the present embodiment, in the first and second receivers 3 and 5 that are control devices, application software utilizing a DCM for controlling digital AV devices 4 and 6 to 9 that are devices targeted for control is made available automatically.

In addition, in the present embodiment, the first and second receivers 3 and 5 that are control devices exist at a DCM acquired from a configuration ROM of a digital AV device that is a device targeted for control or its configuration ROM, and any other portion. Application software is acquired based on identification information (ID) for identifying application software using the DCM and acquisition site information, and application software utilizing the DCM can be easily acquired.

Although not described above, when the first and second receivers 3 and 5 that are control devices acquire a DCM for controlling digital AV devices 4 and 6 to 9 that are devices targeted for control or application software utilizing that DCM from a satellite broadcast or another network such as Internet, it is periodically checked whether or not these DCM or application software is changed. When a change occurs, the fact is notified to a user by displaying the LCD 18 or the like. Alternatively, a DCM or application software is acquired after changed, whereby the software may be overwritten on the RAM 12. In this way, software updating such as bug modification or addition of new function can be performed immediately. The user may be notified by voice output or any other notification means.

Although not described above, the first and second receivers 3 and 5 that are control devices store a predetermined DCM in the RAM 12, and further, stores application software utilizing such DCM. However, when a digital AV device that is a device targeted for control to be controlled by the DCM is not connected to the IEEE 1394 bus 2, the fact may be notified to the user by displaying the LCD 18 or the like. In this way, the user can be prompted to make connection to the IEEE 1394 bus 2 of the digital AV device.

According to the present invention, application software utilizing control information for controlling a device targeted for control is acquired by the device targeted for control or another network, and the application software is made available automatically.

In addition, according to the present invention, control information for controlling a device targeted for control or application software utilizing the control information is acquired by a digital satellite broadcast or another network such as Internet. When the control information or application software is changed, the fact is notified. Alternatively, the control information or application software is acquired after changed, software updating such as bug modification or addition of new functions can be performed immediately.

Further, according to the present invention, when a device targeted for control that corresponds to available application software is not connected to a communication bus, the fact is notified, whereby the user can be prompted to make connection to the communication bus of the device targeted for control.

Additional advantages and modifications will readily occur to those skilled in the art. Therefore, the invention in its broader aspect is not limited to the specific details and representative embodiments shown and described herein. Accordingly, various modifications may be made without departing from the spirit or scope of the general inventive concept as defined by the appended claims and their equivalents.

What is claimed is:

1. A control device for controlling a device targeted for control via a communication bus, said control device comprising:
first storage means for storing control information for controlling said device targeted for control;
second information acquisition means for acquiring application software using said control information stored in said first storage means; and
second storage means for storing said application software acquired by said first information acquisition means.

2. A control device as claimed in claim 1, wherein said application software utilizes a plurality of control information for controlling a plurality of said device targeted for control.

3. A control device as claimed in claim 1, further comprising second information acquisition means for acquiring said control information stored in said first storage means.

4. A control device as claimed in claim 3, wherein said second information acquisition means acquires said control information when said device targeted for control is connected to said communication bus.

5. A control device as claimed in claim 3 wherein said second information acquisition means acquires sad control information from said device targeted for control.

6. A control device as claimed in claim 3, wherein said second information acquisition means acquires said control information from another network.

7. A control device as claimed in claim 6, further comprising change detecting means for detecting a change of said control information distributed via said another network.

8. A control device as claimed in claim 7, wherein said second information acquisition means acquires said control information from said another network when a change of said control information is detected by said change detecting means.

9. A control device as claimed in claim 7, further comprising notification means for, when a change of said control information is detected by said change detecting means, notifying the detected change.

10. A control device as claimed in claim 1, wherein said first information acquisition means acquires said application software by referring to identification information and acquisition site information on the application software.

11. A control device as claimed in claim 10, wherein said identification information and acquisition site information is contained in said control information.

12. A control device as claimed in claim 10, wherein said device targeted for control holds said identification information and acquisition site information.

13. A control device as claimed in claim 1, wherein said first information acquisition means acquires said application software when said controlled control device is connected to said communication bus.

14. A control device as claimed in claim 1, wherein said fist acquisition means acquires said application software from said device targeted for control.

15. A control device as claimed in claim 1, wherein said first information acquisition means acquires said application software from another network.

16. A control device as claimed in claim 15, further comprising change detecting means for detecting a change of said application software distributed via said another network.

17. A control device as claimed in claim 16, wherein said first information acquisition means acquires said application software from said another network when a change of said application software is detected by said change detecting means.

18. A control device as claimed in claim 16, further comprising notifying means for, when a change of said application software is detected by said change detecting means, notifying the detected change.

19. A control device as claimed in claim 1, further comprising notification means for, when a device targeted for control to be controlled utilizing application software stored in said second storage means is disconnected with said communication bus, notifying the disconnection with said communication bus.

20. A method of controlling a control device for a device targeted for control via a communication bus, comprising the steps of:
acquiring application software utilizing control information for controlling said device targeted for control stored in first storage means; and
storing said acquired application software in second storage means.

21. A control method as claimed in claim 20, wherein said application software utilizes a plurality of control information for controlling a plurality of said controlled information.

22. A control method as claimed in claim 20, further comprising the step of acquiring said control information stored in said first storage means.

23. A control method as claimed in claim 22, wherein the step of acquiring said control information is performed when said device targeted for control is connected to said communication bus.

24. A control method as claimed in claim 22, wherein the step of acquiring said control information acquires said control information from said control information.

25. A control method as claimed in claim 22, wherein the step of acquiring said control information acquires said control information from another network.

26. A control method as claimed in claim 25, further comprising the step of detecting a change of said control information distributed in said another network.

27. A control method as claimed in claim 26, wherein the step of acquiring said control information is performed when a change of said control information is detected.

28. A control method as claimed in claim 26, further comprising means for, when a change of said control information is detected, notifying the fact.

29. A control method as claimed in claim 20, wherein the step of acquiring said application software acquires said application software by referring to identification information and acquisition site information of the application software.

30. A control method as claimed in claim 29, wherein said identification information and acquisition site information is contained in said control information.

31. A control method as claimed in claim 29, wherein said device targeted for control holds said identification information and acquisition site information.

32. A control method as claimed in claim 20, wherein the step of acquiring said application software is performed when said device targeted for control is connected to said communication bus.

33. A control method as claimed in claim 20, wherein the step of acquiring said application software acquires said application software from said device targeted for control.

34. A control method as claimed in claim 20, wherein the step of acquiring said application software acquires said application software from another network.

35. A control method as claimed in claim 34, further comprising the step of detecting a change of said application software distributed in said another network.

36. A control method as claimed in claim 35, wherein the step of acquiring said application software is performed when a change of said application software is detected.

37. A control method as claimed in claim 35, further comprising the step of, when a change of said application software is detected, notifying the detected change.

38. A control method as claimed in claim 20, further comprising the step of: when a device targeted for control to be controlled utilizing application software stored in said second storage means is disconnected with said communication bus, notifying the disconnection with said communication bus.
